(19) United States
(12) Patent Application Publication
(10) Pub. No.: US 2025/0307054 A1
(43) Pub. Date: Oct. 2, 2025

(54) Methods and Systems for Data Platform Monitoring and Auditing

(71) Applicant: T-Mobile Innovations LLC, Overland Park, KS (US)

(72) Inventors: Terri BLY, Kirkland, WA (US); Sanjay GAROTHAYA, Ashburn, VA (US)

(21) Appl. No.: 18/620,519

(22) Filed: Mar. 28, 2024

(51) Int. Cl. G06F 11/07; G06F 11/30; G06F 11/32; G06F 11/34

(52) U.S. Cl. CPC G06F 11/0784; G06F 11/3006; G06F 11/323; G06F 11/3476

(57) ABSTRACT

A method comprises monitoring, by a monitoring application of a monitoring system, a plurality of data events across one or more data platforms in the communication network, wherein each of the data events corresponds to an encryption operation or a decryption operation of a data record in the one or more data platforms, recording, by the monitoring application, each of the data events into an event record, wherein each event record corresponding to a data event indicates at least one of client data describing a client associated with the data event, the data record associated with the data event, a key used for the data event, whether the data event corresponds to the encryption operation or the decryption operation, or a timestamp of the data event, and generating, by the monitoring application, different types of usage and access records based on the event records.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Data platforms in the cloud may offer comprehensive solutions for storing, managing, and processing data. These platforms typically provide a diverse array of services, accommodating various data types and usage scenarios. Leveraging global data centers, the data platforms may ensure widespread accessibility and high availability of data. In some cases, cloud-based data platforms may use warehousing solutions that separate storage and compute resources in a scalable and elastic manner to adapt to fluctuating workloads efficiently. The cloud-based data platforms may prioritize data security through robust encryption and decryption measures, sometimes varying across the different platforms and varying based on the types of data stored at the platforms. Key management systems may also be utilized to securely manage the keys used for encryption and decryption of the data across the platforms.

### SUMMARY

In an embodiment, a method implemented in a communication network to perform data platform monitoring and auditing is disclosed. The method comprises monitoring, by a monitoring application of a monitoring system in the communication network, a plurality of data events across one or more data platforms in the communication network, wherein each of the data events corresponds to an encryption operation or a decryption operation of a data record in the one or more data platforms, and recording, by the monitoring application, each of the data events into an event record, wherein each event record corresponding to a data event indicates at least one of client data describing a client associated with the data event, the data record associated with the data event, a key used for the data event, whether the data event corresponds to the encryption operation or the decryption operation, or a timestamp of the data event. The method further comprises generating, by the monitoring application, client usage records based on first event records detailing a first set of one or more data events caused by a request from the client, generating, by the monitoring application, data access records based on second event records detailing a second set of one or more data events associated with the encryption operation or the decryption operation performed on the data record, generating, by the monitoring application, key usage records based on third event records detailing a third set of one or more data events in which a key was used during the encryption operation or the decryption operation, and generating, by the monitoring application, platform usage records based on fourth event records detailing a fourth set of one or more data events occurring at a data platform. The method further comprises performing, by the monitoring application, an action associated with at least one of the data records, the key, or the client based on at least one of the event records, the client usage records, the data access records, the key usage records, and/or the platform usage records.

In another embodiment, a method implemented in a communication network to perform data platform monitoring and auditing is disclosed. The method comprises monitoring, by a monitoring application of a monitoring system in the communication network, a plurality of data events across one or more data platforms in the communication network, wherein each of the data events corresponds to an encryption operation or a decryption operation of a data record in the one or more data platforms, and recording, by the monitoring application, each of the data events into an event record, wherein each event record corresponding to a data event indicates at least one of client data describing a client associated with the data event, the data record associated with the data event, a key used for the data event, whether the data event corresponds to the encryption operation or the decryption operation, or a timestamp of the data event. The method further comprises generating, by the monitoring application, client usage records based on first event records detailing a first set of one or more data events caused by a request from the client, generating, by the monitoring application, key usage records based on second event records detailing a second set of one or more data events in which a key was used during the encryption operation or the decryption operation, and determining, by the monitoring application, a frequency that the client used the key for encryption or decryption across the one or more data platforms based on the key usage records. The method further comprises comparing, by the monitoring application, the frequency with a threshold indicated in a rule associated with the client to determine whether the frequency is less than the threshold, and when the frequency is less than the threshold, preventing, by the monitoring application, the client from using the key for future encryption or decryption operations across the one or more data platforms, and causing, by the monitoring application, one or more active directories of the one or more data platforms to indicate that the client is prohibited from using the key.

In yet another embodiment, a method implemented in a communication network to perform data platform monitoring and auditing is disclosed. The method comprises monitoring, by a monitoring application of a monitoring system in the communication network, a plurality of data events across one or more data platforms in the communication network, wherein each of the data events corresponds to an encryption operation or a decryption operation of a data record in the one or more data platforms, and recording, by the monitoring application, each of the data events into an event record, wherein each event record corresponding to a data event indicates at least one of client data describing a client associated with the data event, the data record associated with the data event, a key used for the data event, whether the data event corresponds to the encryption operation or the decryption operation, or a timestamp of the data event. The method further comprises generating, by the monitoring application, client usage records based on event records detailing a set of one or more data events triggered by a request from the client, generating, by the monitoring application, a periodic usage report for the client based on the client usage records, wherein the periodic usage report indicates data associated with operations performed across the one or more data platforms by the client within a predefined period of time, and transmitting, by the monitoring application, the periodic usage report to the client.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to an embodiment of the disclosure.

FIG. 2 is a diagram illustrating operations performed by a monitoring system of the communication network shown in FIG. 1 according to various embodiments of the disclosure.

FIG. 3 is a flowchart of a first method of data platform monitoring and auditing according to various embodiments of the disclosure.

FIG. 4 is a flowchart of a second method of data platform monitoring and auditing according to various embodiments of the disclosure.

FIG. 5 is a flowchart of a third method of data platform monitoring and auditing according to various embodiments of the disclosure.

FIG. 6 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A data platform is a scalable and flexible system allowing clients (e.g., customers, users, service accounts, organizations, etc.) to store, organize, and analyze data using remote servers and computing resources. A data platform may be implemented, for example, across one or more of cloud systems, edge servers, local servers, etc. Clients may use a variety of different data platforms for data management, each with different environments, conditions, and permissions. Nevertheless, each data platform stores data records on behalf of many clients, secure the data records using sophisticated encryption and decryption methods, security keys, permissions, and/or other security mechanisms.

A data platform may be configured to enable various different types of encryption/decryption schemes using various different encryption and decryption algorithms. For example, a data platform may use column-based encryption/decryption schemes and/or record-based encryption/decryption schemes. In a column-based encryption/decryption scheme, each column of a table (storing the data records) may be encrypted/decrypted using different keys and/or different encryption/decryption algorithms. In a record-based encryption/decryption scheme may, each data record in a table may be encrypted/decrypted using a different key and/or a different encryption/decryption algorithm (which may be identified in a header of a ciphertext of the data record). Details regarding the record-based encryption/decryption scheme is further described in co-pending U.S. Pat. App. No. XX/XXX,XXX, entitled “Ciphertext Header-Based Data Security,” by Terri Bly, et. al., which is hereby incorporated by reference in its entirety. Therefore, data platforms may be adequately equipped to ensure efficient and secure data access, storage, and management.

However, data platforms may not be programmed to monitor the usage of the keys and access to the data records for purposes of auditing, generating reports, detecting anomalies or improper usage of the keys, and/or suggesting efficient function calls for the data records. Clients owning the data records at the data platforms or accessing the data records at the data platforms may thus lack knowledge regarding access to and use of the data records, which may otherwise be considered significant for organizational and/or financial planning purposes. Moreover, the data platforms may sometimes experience minor to severe technical problems as a result of not monitoring and auditing the data records and keys at the data platform. For example, improper access to keys and/or suspicious activity by certain classes of clients at a data platform may give rise to data breaches (e.g., compromising sensitive information), compromised data integrity (e.g., malicious manipulation of the data), regulatory and/or organizational non-compliance, (e.g., improper access resulting in a violation of regulations and policies), operational disruptions (e.g., causing system downtime and affecting availability of services), theft of proprietary information, etc. In this way, the lack of monitoring and auditing operations at the data platforms may result in lower security and lower processing/resource efficiencies across the data platforms.

The present disclosure addresses the foregoing technical problems by providing a technical solution in the technical field of data platform management and security by implementing a monitoring system, as either part of each data platform or communicatively coupled to each data platform. The monitoring system may include a monitoring application that may monitor and log all data events occurring across one or more data platforms. A data event may refer to one or more operations performed on the data records or using the keys at the data platforms. For example, a data event may occur when encryption is performed on a data record at a data platform or when decryption is performed on a data record at a data platform. The logged data events may be analyzed and used by the monitoring application to perform various functions, as further described herein. In this way, the embodiments disclosed herein provide technical solutions to the technical problems described above, by monitoring the usage of the keys and access to the data records for purposes of auditing, detecting anomalies or improper usage, and/or suggestions for providing more efficient function calls.

In an embodiment, the monitoring application may monitor all data events across the data platforms. The monitoring application may monitor and log data associated with each request received from a client to encrypt a data record or decrypt a data record at a data platform. The data associated with each request may indicate whether the request is to encrypt or decrypt, the data record that is the subject of the request, the client submitting the request, a number of values or data records encrypted or decrypted based on the request, whether the request was successful/unsuccessful, a reason behind an unsuccessful or denied request, etc. For example, the monitoring application may monitor and log data associated with a frequency of a client accessing certain data records and/or accessing a data platform within a period of time, a volume of data landing into a data platform from a client, etc. The monitoring application may record and store this data into one or more event records. An event record may be a data structure (e.g., table) or an entry in a data structure (e.g., a row in a table) storing the data associated with each of the monitored data events. There may be multiple event records (e.g. tables), each corresponding to, for example, a different data platform, a different client, a different dataset stored at the data platform, a different key or set of keys used for encryption/decryption, etc. Alternatively, there may be a single event record (e.g., table) logging every data event monitored by the monitoring application.

Each event record for a data event may store data associated with or describing the data event. For example, each event record may include client data describing a client associated with the data event (e.g., the client requesting encryption or decryption of a data record), the data record (e.g., that is the subject of the request or that is being monitored for access by one more clients within a time period), a key (e.g., used to encrypt or decrypt the data record), an event type (e.g., an operation performed on the data record/using the key, whether the data event corresponds to an encryption of the data record or a decryption of the data record), time data associated with the data event (e.g., timestamp of the data event, a duration of the data event), etc. The event records may be stored in a repository (e.g., collection of one or more memories) at the monitoring system.

The monitoring application may aggregate and analyze the event records to determine various types of usage and access parameters associated with the data events, for example, within a predefined period of time (e.g., daily, hourly, etc.). For example, the usage and access parameters may include client-specific parameters that relate to the usage and access (e.g., the operations performed on the data records or using keys) of one or more data platforms by a particular client. These client-specific parameters may be stored in the repository as a client usage record associated with the predefined period of time. For example, the client usage records may indicate that the client has accessed N number of data records at data platforms A and B over the predefined period of time. Alternatively, or in addition, the client usage records may indicate that the client has used a particular key for encryption and/or decryption at a data platform N number of times. In this way, the client usage records may be a value associated with a type of usage or data event-related parameter collected over the predefined period of time that is specific to a single client or a grouping of clients.

Another type of usage and access parameter generated by the monitoring application using the event records may include data access parameters, which may be stored in the repository as data access records associated with the predefined period of time. For example, the data access records may indicate that a data record has been accessed by one or more clients N number of times in the predefined period of time. Alternatively or in addition, the data access records may indicate that a set of data records or a class of data records have been accessed by one or more clients N number of times in the predefined period of time. In this way, the data access records may be a value associated with a type of usage or data event-related parameter collected over the predefined period of time that is specific to a single data record or a group of data records.

Another type of usage and access parameter generated by the monitoring application using the event records may include key usage parameters, which may be stored in the repository as key usage records associated with the predefined period of time. For example, the key usage records may indicate that a key has been used for encryption (and/or decryption) by one or more clients N number of times in the predefined period of time. Alternatively, or in addition, the key usage records may indicate that a key has been successfully or unsuccessfully used for encryption by one or more clients N number of times in the predefined period of time. Alternatively, or in addition, the key usage records may indicate that a key has been successfully or unsuccessfully used for decryption by one or more clients N number of times in the predefined period of time. In this way, the key usage records may be a value associated with a type of key use or data event-related parameter collected over the predefined period of time that is specific to a single key.

Another type of usage and access parameter generated by the monitoring application using the event records may include platform usage parameters, which may be stored in the repository as platform usage records associated with the predefined period of time. For example, the platform usage records may indicate that a platform has been accessed by one or more clients N number of times in the predefined period of time. Alternatively, or in addition, the platform usage records may indicate that a set of data records or a class of data records have been accessed by one or more clients N number of times in the predefined period of time. In this way, the platform usage records may be a value associated with a type of platform data event-related parameter collected over the predefined period of time that is specific to a platform.

The event records and the different usage and access records maintained in the repository may be used by the monitoring application to perform different types of auditing and governance actions on the data records and/or keys at the data platforms or with respect to a client. For example, the monitoring application may generate periodic (e.g., weekly, monthly, etc.) usage reports to send to individual clients that are using/accessing the data records across one or more data platforms. The usage reports may be generated based on, for example, the event records associated with the client and the client usage records of a client. The monitoring application may present data from the event records and client usage records in the usage report in a visually organized and readable format (e.g., using text, tables, and/or graphs with specific colors, etc.). For example, the usage report may indicate that the client performed encryption operations at a data platform one million times over a one-month period of time. The usage report may also compare the client usage with historical client usage for the same operations/data records/data platforms, for reference and comparison. The monitoring application may derive the historical client usage for the same operations/data records/data platforms based on a history of the client usage records and/or event records 126 maintained at the repository of the monitoring system.

The monitoring application may also have access to one or more rules, for example, stored in the repository and programmed into the monitoring system by an operator or a programmer of the monitoring system. The rules may indicate one or more conditions, that when met, may trigger the monitoring application to instruct or take certain types of actions in response to the condition. For example, the rules may include a condition indicating that when a frequency that a client used a key for encryption and/or decryption on one or more data records is less than a threshold value, then the monitoring application may instruct the data platform to prevent the client from using the key for future encryption or decryption operations at the data platform. This may be the case when certain clients receive access to keys that are infrequently or in some cases never used by the clients, indicating that the client has received unrestrained/improper access to certain keys. In other words, when clients have access to keys that are not used, the keys are vulnerable to attacks and other types of misuse. The monitoring application may be programmed to detect when clients do not use a key that the client is permitted to use within a predefined period of time (e.g., an extended period of time), such that the monitoring application may adjust the client permissions when the key is not used by the client within the period of time. This adjustment to the client permission may reflect that the client has never used the keys in the past (and should never use the keys in the future), and any future use of the key by the client may be deemed a suspicious activity (as further described below). For example, the monitoring application may use the event records, key usage records, and client usage records to determine a frequency that the client used a particular key for encryption and/or decryption across one or more data records in a predefined period of time. For example, the monitoring application may instruct an application at one or more data platforms to deny future requests from the client to encrypt or decrypt a data record using the key. The monitoring application may also instruct the data platforms to update their local active directories to indicate that the client no longer has permission to use the key for encryption and/or decryption operations.

As another example, the monitoring application may use client usage records over a predefined period of time and/or historical client usage records of a client to identify suspicious (e.g., unusual) activity by the client across one or more data platforms, and in some cases, offer suggestions for more efficient function calls to resolve the improper activity. Suspicious activity may be identified as a relevant departure from a baseline or average usage/access count or rate of a data record and/or a key by a client. For example, the monitoring system may maintain a history of client usage records pertaining to a particular data record and/or key, and the monitoring application may determine a baseline usage frequency range of the data record and/or key (e.g., based on an average client usage within a predefined period of time). The monitoring application may identify a suspicious activity when a current usage of the data record and/or key is beyond the baseline usage frequency range. Alternatively, the historical client usage records may indicate all of the data records and/or keys used by a client for an extended period of time, such that a monitoring application may identify a suspicious activity by the client when the client accesses a new data record and/or key. In this way, the client usage records of the client may indicate whether the client is requesting access to a data platform that the client has never accessed before, and/or the client usage records may indicate a number of access requests to the data platform by the client. The monitoring application may identify a rule that when the client requests access to a new data platform greater than a threshold number of times, the monitoring application may be instructed to perform certain auditing or governance actions. For example, the monitoring application may notify the client of the detected activity (e.g., requesting access to the data platform greater than a threshold number of times), and request to receive confirmation from the client on the requested activity (to reduce fraud/hacking at the data platform).

As another example, the client usage records of the client may indicate a number data records upon which encryption/decryption was performed for the client, a number of times a key was used for encryption/decryption, and/or other numbers and counts related to data record access and key usage. A rule may indicate that when the client has requested decryption for over a threshold number of rows (or data entries), the monitoring application may be instructed to perform certain auditing or governance actions to suggest efficient function calls for the data records (e.g., in which the efficient function call recommend the client to search for an encrypted value rather than decrypting numerous rows to search for a data record). By searching for the encrypted value itself instead of decrypting numerous rows to search for the data record, processing power and resources that would have otherwise been used for searching/decrypting may be conserved. The amount of processing power and resources used for searching for the encrypted value may be far less than the amount of power and resources used for decrypting numerous rows searching for a data record. Another rule may indicate that when the client has never used a key that the client has permission to use, the monitoring application may be instructed to perform certain auditing or governance actions (e.g., update the active directories at the data platforms to indicate that the client is no longer permitted to use the key/prevent the client from using the key at the data platforms).

As yet another example, the monitoring application may use at least one of the event records, the client usage records, the data access records, the key usage records, the platform usage records, and all other types of records, and the rules to govern data events (e.g., encryption or decryption) by one or more clients on one or more data records across one or more data platforms. For example, rules may correspond to government regulations, contractual provisions, organization policies, industry standards, etc., each related to the data events that may occur at the data records across the data platforms. A data platform may store government data that is highly sensitive, and government regulations may indicate that the platform is to provide a report summarizing all data events associated with the data records storing the government data. The monitoring application may use the records to generate the report summarizing all data events associated with the data records storing the government data, and transmit the report back to the client.

As mentioned above, the rules used to determine auditing or governance actions may be based on conditions related to the different records maintained at the repository of the monitoring system. The conditions may be associated with, for example, one or more clients, one or more keys, and one or more of the records maintained by the repository at the monitoring system. For example, a condition may be based on a comparison between a record and a preset threshold, such that a governance action is to be performed by the monitoring application when the record either exceeds the preset threshold or is less than the preset threshold. A rule may indicate that when a condition is met, the monitoring application is to perform one or more governance actions to govern encryption and decryption operations on the data records. The governance actions may include, for example, sending a notification to the client, preventing/restricting access to and/or use of a key, preventing/restriction access to a data record, allowing access to and/or use of a key, allowing access to a data record, etc.

Therefore, the embodiments disclosed herein monitor the data events across one or more data platforms to record the usage of keys, access to data records, and identify improper (e.g., suspicious/unusual) activities, anomalies, and/or inconsistencies in data events associated with various clients. The embodiments disclosed herein may be instructed to perform one or more different types of auditing or governance actions with respect to the data records, keys, and/or clients that are associated with a detected condition. In this way, the embodiments disclosed herein prevent various technical problems from occurring at a data platform, that may otherwise result in a data breach, operational disruption, or other type of technical problem across the data platforms. By preventing such problems from occurring at the data platforms, the embodiments disclosed herein thus increase resource capacity and data access/management efficiency at the data platforms.

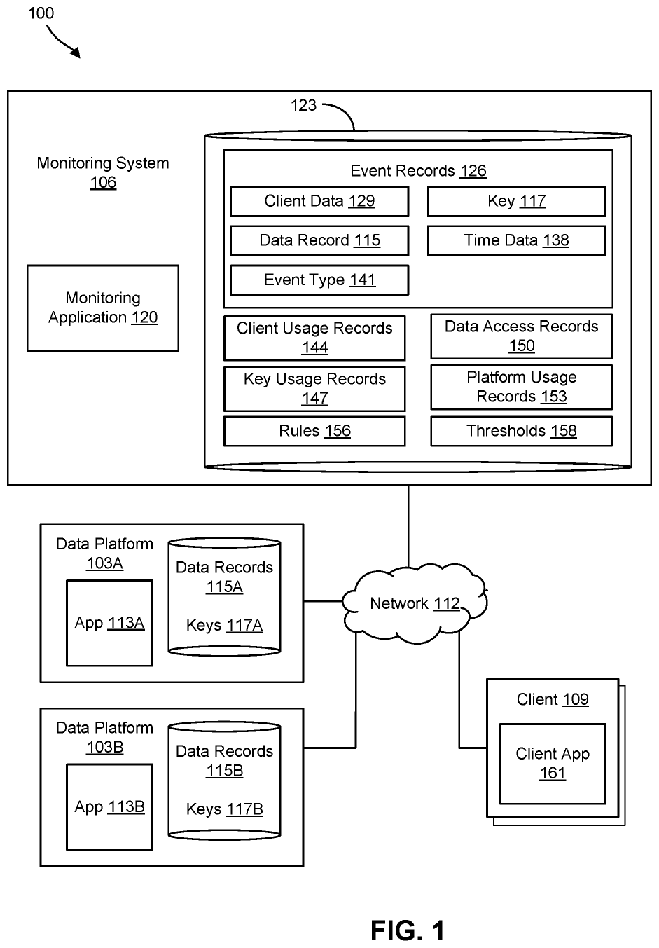

Turning now to FIG. 1, a communication network 100 is described. The communication network 100 comprises data platforms 103A-B, a monitoring system 106, one or more clients 109, and a network 112. While the data platforms 103A and 103B and monitoring system 106 are shown as separate from the network 112, in other embodiments, the data platforms 103A-B and monitoring system 106 may be part of the network 112. The network 112 may be one or more private networks, one or more public networks, or a combination thereof.

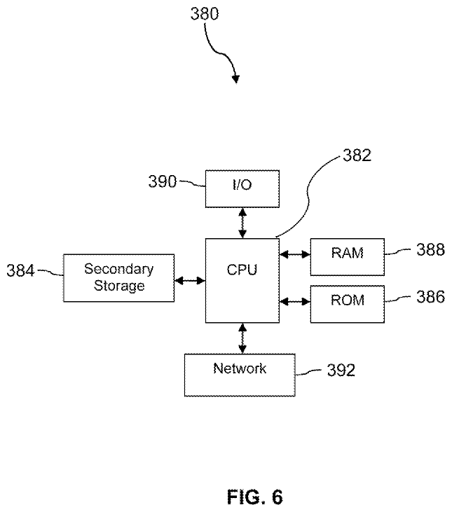

A client 109 may be a device owned and operated by a user or organization (e.g., customer, service account, etc.), which may be a customer and contracted with one or more of the data platforms 103A-B, to store data records 115A-B remotely at the data platforms 103A-B. For example, the client 109 may refer to a user equipment (UE) (e.g., smartphone, tablet, laptop, desktop computer, wearable device, camera, gaming console, point-of-sale terminals, automated teller machines, drones, etc.) or other type of computer system (e.g., similar to the computer system described in FIG. 6) that may be used to communicate with one or more data platforms 103A and 103B. The client 109 may run a client application 161, which may be instructions stored on a memory of the client 109 and executable by a processor of the client 109 to perform various operations, such as, sending requests (e.g., function calls) to one or more data platforms 103A and 103B.

The data platforms 103A and 103B may be systems for storing, organizing, and analyzing data using remote servers and computing resources, which may be, for example, cloud-based, edge-based, or local. The data platforms 103A and 103B may be a computer system, server software/hardware, or a collection of processors, memories, and/or networking resources. Each data platform 103A and 103B may include one or more repositories or memories that store data records 115A and 115B, respectively, on behalf of various clients 109, and keys 117A and 117B that may be used to perform encryption and/or decryption operations on the data records 115A and 115B. Each data platform 103A and 103B may also include an application 113A and 113B, respectively, that performs operations on the data records 115A and 115B. In particular, data platform 103A may include application 113A and stores data records 115A and keys 117A, while data platform 103B may include application 113B and stores data records 115B and keys 117B.

Data records 115A and 115B may refer to any type of data, file, or metadata that may be stored and maintained remotely from the client 109 (e.g., owner) of the data record 115A and 115B. The keys 117A and 117B may be data or a string of characters that may be used to perform encryption operations on the data records 115A and 115B (e.g., transform raw data from the data records 115A and 115B into ciphertext) and may be used to decrypt the ciphertext of the data records 115A and 115B (e.g., transform the ciphertext back into the raw data of the data records 115A and 115B). In this way, the term data records 115 and 115B may refer the raw data (e.g., upon which encryption has not been performed) or ciphertext (upon which encryption has been performed). The data records 115A and 115B and keys 117A and 117B may be stored at the data platforms 103A and 103B in various different types of formats using various different types of security mechanisms, which may be specific to the data platform 103A and 103B.

A client 109 may be contracted with and/or a customer of both the data platforms 103A and 103B, and in this way, the client 109 may potentially store and access data records 115A and 115B at both the data platforms 103A and 103B. The client 109 may also use the security mechanisms (e.g., encryption and decryption operations) offered by the data platforms 103A and 103B when storing or accessing data records 115A and 115B.

When a client 109 transmits a request (e.g., a function call) including a data record 115A to encrypt the data record 115A for storage at the data platform 103A, the application 113A may first determine whether the client 109 is permitted to not only encrypt a data record 115A for storage at the data platform 103A, but also determine whether the client 109 is permitted to use a key 117A (e.g., based on permission data stored in an active directory of the data platform 103A) for encryption. In some cases, the request received from the client 109 may include the key 117A. In other cases, the request may not include the key 117A, and the application 113A may determine the key 117A based on the type of data record 115A received from the client 109. When the client 109 is permitted to encrypt a data record 115A using a key 117A, the application 113A may perform encryption on the data record 115A using the key 117A and store the encrypted data record 115A at the data platform 103A.

As another example, the client 109 may transmit, to the data platform 103B a request (e.g., a function call) including an encrypted data record 115B to decrypt the encrypted data record 115B at the data platform 103B. The application 113B may first determine whether the client 109 is permitted to not only decrypt a data record 115A at the data platform 103B, but also determine whether the client 109 is permitted to use the key 117B for decryption (e.g., based on permission data stored in an active directory of the data platform 103B). As mentioned above, the request received from the client 109 may include the key 117B or in some cases, may not include the key 117B. In either case, the application 113B may either obtain the key 117B from the request or identify the key 117B based on the data record 115B. When the client 109A is permitted to decrypt the data record 115B using the key 117B, the application 113B may perform decryption on the data record 115B using the key 117B.

While only two data platforms 103A and 103B are shown in FIG. 1, it should be appreciated that the communication network 100 may include any number of data platforms 103A-B. FIG. 1 shows two data platforms 103A-B for illustrative purposes only, to demonstrate that clients 109 may use multiple data platforms 103A and 103B, and that a monitoring system 106 may be coupled to and programmed to operate across multiple data platforms 103A and 103B, as further described herein.

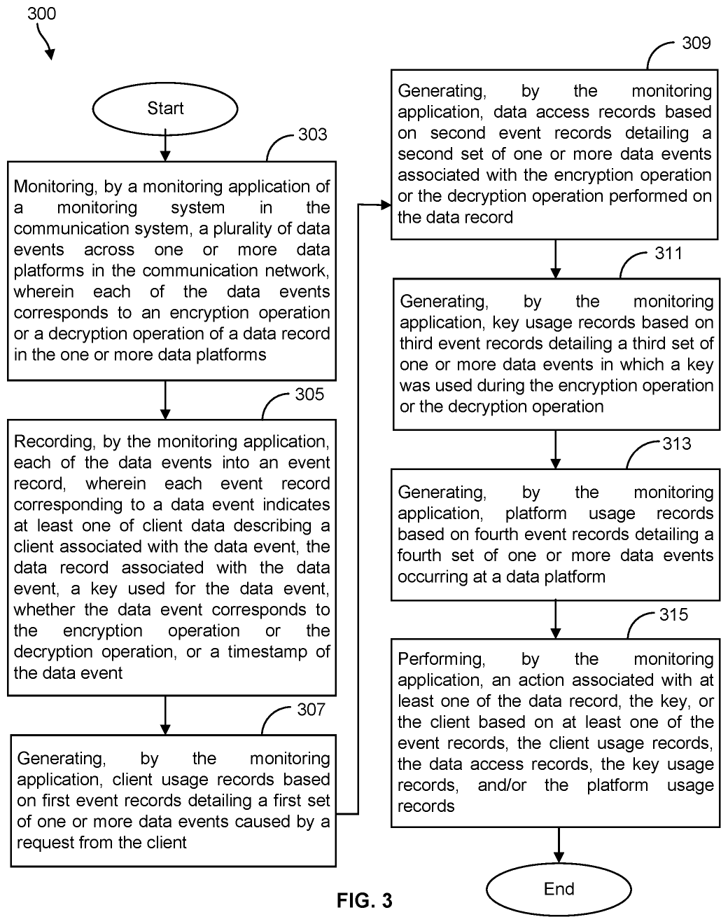

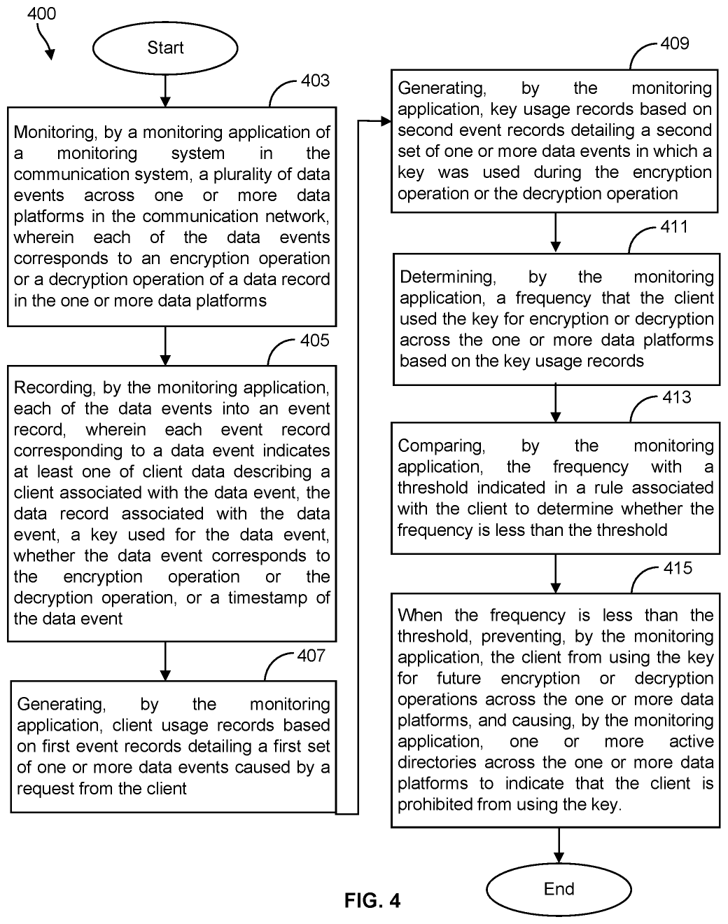

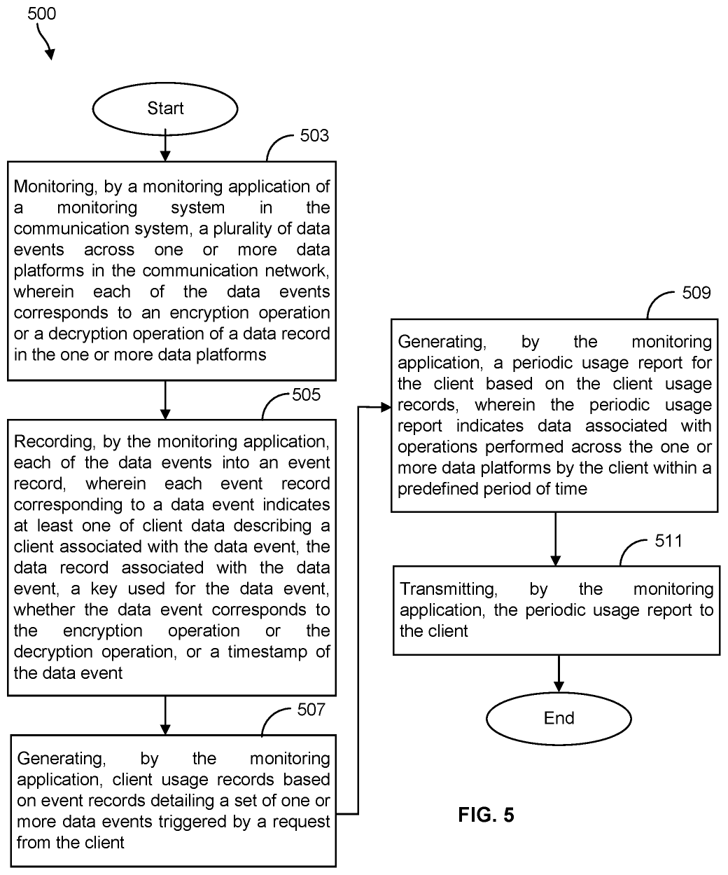

The monitoring system 106 may be a computer system, server software/hardware, or a collection of processors, memories, and/or networking resources, used to implement a monitoring application 120. The monitoring application 120 may refer to instructions stored at a memory of the monitoring system 106, which when executed by a processor of the monitoring system 106, is configured to perform the steps described herein (e.g., in methods 300 of FIG. 3, 400 of FIG. 4, and 500 of FIG. 5). The monitoring system 106 may also include a repository 123 (e.g., one or more memories) for storing various types of data and records collected by the monitoring application 120.

While the monitoring application 120 is depicted as separate from the data platforms 103A and 103B, in some embodiments, the monitoring application 120 may be provisioned within the data platform 103A and 103B. For example, the monitoring application 120 may be another application executed by the data platform 103A, which collects data and sends the data back to the repository 123 at the monitoring system 106 (which may be external to the data platform 103A). However, some data platforms 103B may not allow the provisioning of the monitoring application 120 within the data platform 103B itself. In such a case, the monitoring application 120 may be executed external to the data platform 103B at the monitoring system 106, but may be authenticated with the data platforms 103B to monitor and audit the data events at the data platform 103B.

The monitoring application 120 may monitor all data events occurring across all the data platforms 103A and 103B in the communication network 100. A data event may refer to any operation performed at the data platforms 103A and 103B. In some cases, a data event may be based on a trigger event, such as, for example, a request received from a client 109. For example, the request may be a request to encrypt a data record 115A or 115B for storage at a data platform 103A or 103B, to decrypt a data record 115A or 115B stored at a data platform 103A or 103B, or any other type of operation performed with respect to a data record 115A or 115B at a data platform 103A or 103B.

The monitoring application 120 may detect the occurrence of a trigger event (which may be the first operation/task in a data event) and then begin monitoring and logging each operation/task in the data event into an event record 126 for storage at the repository 123. For example, the monitoring application 120 may detect that the client 109 has sent a request to encrypt a data record 115 to the data platform 103A. Upon detection of this request, the monitoring application may begin logging details of the data event (e.g., the client 109 that triggered the data event, the data record 132 that is the subject of the data event, the keys 117A or 117B used in the data event, the type of function call in the request received from the client 109, whether the request was permitted, successful, denied, and/or unsuccessful, a time of the data event, etc.). These details may be recorded into an event record 126 associated with the monitored data event. For example, the event record 126 may store client data 129, the data record 115A or 115B (shown in FIG. 1 as “data record 115”), the key 117A or 117B (shown in FIG. 1 as “key 117”), time data 138, event type 141, and/or any other data associated with the data event. The client data 129 may describe the client 109 associated with the data event (e.g., an address or identifier of the client 109, a name of a user/organization operating the client 109, etc.). The data record 115A or 115B may refer to the actual data upon which the operation of the data event is being performed. The key 117A or 117B may refer to the key used during the operation performed in the data event. The time data 138 may refer to a time, date, and/or duration of the data event. The event type 141 may indicate the type of operation being performed in the data event (e.g., may carry a first value indicating that an encryption operation is being performed in the data event, a second value indicating that a decryption operation is being performed in the data event, a third value indicating that a read operation is being performed in the data event, a fourth value indicating that write operation is being performed in the data event, etc.).

The monitoring application 120 may use the data from the event records 126 collected over a predefined period of time, to determine various usage and access parameters associated with the data events. The usage and access parameters may be recorded and stored in the repository 123 as, for example, client usage records 144, key usage records 147, data access records 150, and platform usage records 153. The client usage records 144 may be a value associated with data events related to a single client 109 or grouping of clients 109 over the predefined period of time. The key usage records 147 may be a value associated with data events involving the use of a single key 117A or 117B or grouping of keys 117A or 117B over the predefined period of time. The data access records 150 may be a value associated with data events involving a single data record 115A or 115B or a grouping of data records 115A or 115B. The platform usage records 153 may be a value associated with data events occurring at a single data platform 103A or 103B.

The monitoring application 120 may perform auditing or governance actions, or instruct the performance of auditing or governance actions, based on the event records 126, client usage records 144, key usage records 147, data access records 150, platform usage records 153, and/or any other type of record maintained in the repository 123, and further based on rules 156. The rules 156 may refer to one or more conditions that, when met, may instruct the monitoring application 120 to perform certain auditing or governance actions (or instruct the monitoring application 120 to instruct the performance of auditing or governance actions at the data platforms 103A and/or 103B). The conditions in the rules 156 may involve the comparison of one or more of the client usage records 144, key usage records 147, data access records 150, or platform usage records 153, with one or more thresholds 158 (e.g., that are preset into the system). For example, a rule 156 may indicate that when one or more of the client usage records 144, key usage records 147, data access records 150, or platform usage records 153 is less than a threshold 158, a first auditing or governance action is to be performed by the monitoring application 120. As another example, a rule 156 may indicate that when one or more of the client usage records 144, key usage records 147, data access records 150, or platform usage records 153 is greater than a threshold 158, a second auditing or governance action is to be performed by the monitoring application 120. As described herein, the auditing or governance actions may include generating a report, notifying a client 109 of a suspicious data event or activity, preventing the client 109 from using a key 117A or 117B, preventing the client 109 from encrypting and/or decrypting a data record 115A or 115B, denying all requests from the client 109, etc.

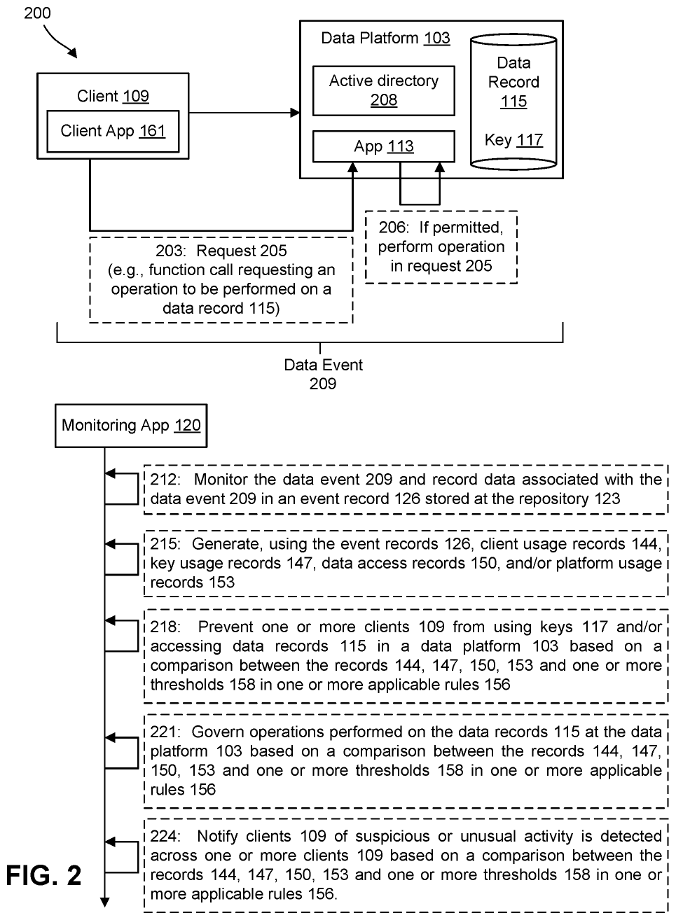

The different records 126, 144, 147, 150, and 153 may be collected over time to essentially store a history of records 126, 144, 147, 150, and 153 related to all of the historical data events 209 (described in FIG. 2) occurring at the data platforms 103A and 103B. For example, different client usage records 144 collected for a client 109 for different predefined periods of time (e.g., a month), may be collected for years, to maintain a history of client usage records 144 over the years. These historical records 126, 144, 147, 150, and 153 may be compared to current records 126, 144, 147, 150, and 153 to identify suspicious data events occurring at the data platforms 103A or 103B, which may be tagged as such in the corresponding event records 126, as further described herein. For example, the monitoring application 120 may use the historical records 126, 144, 147, 150, and 153 to determine baseline usage and access ranges for a particular client 109, for one or more data records 115, and/or for one or more keys 117. The baseline usage and access ranges may be based on one or more statistical approaches, such as, for example, rolling average ranges, standard deviations, etc. The monitoring application 120 may identify a data event, triggered by a client 109, and determine whether an attribute of the data event (e.g., the client 109, the data record 115 that is the subject of the data event, and/or the key 117 used in the data event) falls within the baseline usage and access ranges for a particular client 109, for one or more data records 115, and/or for one or more keys 117 or falls outside the baseline usage and access ranges for a particular client 109, for one or more data records 115, and/or for one or more keys 117. When the attribute of the data event falls within the baseline usage and access ranges for a particular client 109, for one or more data records 115, and/or for one or more keys 117, then the data event may be deemed a normal activity by the client 109. When the attribute of the data event falls outside the baseline usage and access ranges for a particular client 109, for one or more data records 115, and/or for one or more keys 117.

Referring now to FIG. 2, shown is a diagram 200 illustrating a data event 209 and operations performed by the monitoring application 120 based on the data event 209 according to various embodiments of the disclosure. The data platforms 103A and 103B may be referred to hereinafter as a “data platform 103.” Similarly, the data records 115A and data records 115B may be referred to hereinafter as “data record 115,” keys 117A and 117B may be referred to hereinafter as “key 117,” and applications 113A and 113B may be referred to hereinafter as “application 113.”

FIG. 2 illustrates various operations that may occur in a data event 209, which again refers to one or more operations performed at a data platform 103 with respect to a data record 115 and/or a key 117. At step 203, the client application 161 of the client 109 may transmit a request 205 (e.g., a function call) to the data platform 103 requesting an operation to be performed on a data record 115 stored at the data platform 103. The requested operation may be, for example, a read operation, a write operation, an encryption operation, a decryption operation, a search and query operation, a data transformation operation, a backup/restore operation, an access control operation, an indexing operation, a sorting operation, a replication operation, a deduplication operation, an import/export operation, a machine learning operation, a transaction operation, etc. The request 205 may include the data record 115, which is the subject of the request 205 (e.g., the data record 115 to be encrypted and stored at the data platform 103, or a ciphertext data record 115 to be decrypted by the data platform 103). The request 205 may also include an identifier (e.g., value or text) of the operation to be performed at the data platform 103 with respect to the data record 115. The request 205 may also include an identifier or address of the client 109 sending the request 205 and an identifier or address of the destination data platform 103.

The monitoring application 120 may detect that a request 205 has been received at the data platform 103 and determine that a data event 209 has begun at the data platform 103. After identifying the initiation of the data event 209, the monitoring application 120 may begin recording data into the event record 126 for the data event 209 based on the request 205.

The application 113 at the data platform 103 may receive the request 205, and then begin step 206 to first determine whether the client 109 is permitted to perform the operation indicated in the request 205, and then perform the operation when permitted. The data platform 103 may include an active directory 208, which may include data describing permissions associated with various clients 109 that are customers contracted with the data platform 103 (e.g., the permissions for a client 109 may be associated with an identifier of the client 109 at the active directory 208). The application 113 may use the permission data included in the active directory 208 to determine whether the client 109 is permitted to perform the operation indicated in the request 205. For example, the request 205 may be for encryption of a data record 115 and storage of the encrypted data record at the data platform 103. The request 205 may include an identifier of the client 109, the data record 115, and an indication that the request is for encryption and storage. The client application 113 may determine whether the client 109 is permitted to perform encryption, is permitted to access the key 117 used for encryption on the data record 115, and/or is permitted to store the encrypted data record 115 at the data platform 103 based on the permission data in the active directory 208 and the identifier of the client 109 obtained from the request 205.

When the client application 113 determines that the permission data in the active directory 208 indicates that the requested operation may be performed on the data record 115 as requested by the client 109, the client application 113 may perform the requested operation on the data record 115 on behalf of the client 109. The monitoring application 120 may record, in the event record 126 for the data event 209, the permissions that were analyzed by the client application 113 at step 206 and an indication that the request 205 was accepted and successfully performed by the client application 113.

When the client application 113 determines that the permission data in the active directory 208 indicates that the requested operation is not permitted (or prohibited from) being performed on the data record 115 as requested by the client 109, the client application 113 may transmit a notification back to the client 109 indicating that the request 205 may not be performed on behalf of the client 109. The notification may indicate that the client 109 is not permitted to perform the requested operation at the data platform 103. The monitoring application 120 may record, in the event record 126 of the data event 209, the permissions that were analyzed by the application 113 at step 206 and an indication that the request 205 was denied and thus, not performed by the application 113 (e.g., unsuccessful request). The data event 209 may be considered terminated after the steps have been successfully performed/not performed at the data platform 103 and, in some cases, after the client 109 have been notified about the successful or successful performance of the steps.

In this way, the data event 209 begins when a trigger event (e.g., a request 205) is detected at the data platform 103 by the monitoring application 120, the data event 209 includes a series of operations/tasks/steps performed in response to the trigger event, and the data event 209 terminates upon completion of all the operations/tasks/steps associated with the trigger event. Throughout the course of the data event 209, the monitoring application 120 may perform various steps 212, 215, 218, 221, and 224 based on the steps being performed at the client 109 and/or data platform 103 during the data event 209. At step 212, the monitoring application 120 may monitor the data event 209 (e.g., monitor all of the operations/tasks performed during the data event 209) and record data associated with the data event 209 in an event record 126 stored at the repository 123. For example, when the request 205 is to decrypt a data record 115 at the data platform 103, the monitoring application 120 may record, in the event record 126, the client data 129, the data record 115 (e.g., the ciphertext), the key 117 used for decryption, the time data 138 associated with the trigger event and the data event 209, and the event type 141 indicating that the operation to be performed is a decryption operation. The monitoring application 120 may also record, in the event record 126, whether the client 109 is permitted to perform the requested operation, whether the operation was successfully performed at the data platform 103, and/or whether a notification was transmitted back to the client 109 based on the performance/inability to perform the operation at the data platform 103.

At step 215, the monitoring application 120 may generate, using the event records 126, the client usage records 144, key usage records 147, data access records 150, and/or platform usage records 153. Each of these records 144, 147, 150, and 153 may be values reflecting usage and/or access parameters determined based on the data in the event records 126. The monitoring application 120 may perform step 215 periodically to determine the records 144, 147, 150, and 153 periodically either based on a preset schedule or based on the detection of certain events (e.g., a request 205 received by a new client 109, higher than threshold quantity of requests 205 received from a single client 109, etc.).

The monitoring application 120 may then analyze the different records 144, 147, 150, and 153 based on rules 156 to perform/instruct the performance of one or more auditing or governance actions with respect to a client 109, a data record 115, and/or a key 117. Steps 218, 221, and 224 are examples of the auditing or governance actions that may be performed based on an analysis of the records 144, 147, 150, and 153 with respect to the rules 156.

At step 218, the monitoring application 120 may prevent one or more clients 109 from using one or more keys 117 and/or from accessing one or more data records 115 in the data platform 103 based on, for example, a comparison between the client usage records 144, key usage records 147, data access records 150, and/or platform usage records 153 with one or more thresholds 158 in one or more applicable rules 156. For example, the platform usage records 153 may indicate that a client 109 is accessing a data platform 103 for the first time at a frequency of hundreds of requests 205 per hour. A rule 156 may indicate that when a client 109 accesses a data platform 103 for the first time with higher than a threshold count of requests 205 per hour, the monitoring application 120 may be instructed to prevent (or instruct prevention of) the client 109 from accessing the data platform 103 at least for a period of time and to notify the client 109 of this suspicious activity by the client 109. In some cases, the monitoring application 120 may request confirmation from the client 109 that the requests 205 to the data platform 103 are true and do not constitute fraudulent activity, before the monitoring application 120 may permit the requests 205 to be processed by the data platform 103.

At step 221, the monitoring application 120 may govern operations performed on the data records 115 at the data platform 103 based on, for example, a comparison between the client usage records 144, key usage records 147, data access records 150, and/or platform usage records 153 with one or more thresholds 158 in one or more applicable rules 156. For example, a rule 156 may indicate that certain types of reports describing the usage by one or more clients 109 are to be generated and transmitted to the client 109. The monitoring application 120 may generate the reports and transmit the reports to the clients 109 as prescribed in the rule 156. Another rule 156 may indicate that a certain class of clients 109 may only be permitted to perform decryption N number of times (e.g., on N number of values) on data records 115 at a data platform 103. The monitoring application 120 may use the client usage records 144 to identify when a client 109 in the class exceeds the permitted decryption count, to prevent the client 109 from performing a decryption on another data record 115 at the data platform 103.

At step 224, the monitoring application 120 may notify clients 109 when suspicious or unusual activity is detected across one or more clients 109 based on, for example, a comparison between the client usage records 144, key usage records 147, data access records 150, and/or platform usage records 153 with one or more thresholds 158 in one or more applicable rules 156. As mentioned above, the repository 123 may essentially maintain a history of records 126, 144, 147, 150, and 153 related to all data events 209 across one or more data platforms 103. The history of records 126, 144, 147, 150, and 153 stored at the repository 123 may be used to identify when clients 109 may be behaving in a manner that is atypical, abnormal, or suspicious.

For example, the client 109 may have a baseline quantity range of requests 205 sent to the one or more data platforms 103 within a predefined period of time, and these requests 205 may pertain to an expected set of data records 115 or an expected quantity of data records 115 (determined based on the historical client usage records 144). Rules 156 may be preconfigured for each client 109 indicating the historical ranges of activity associated with the client 109, and permitted deviations for the client 109, such that when the current data event 209 of a client 109 exceeds a permitted deviation from a historical range of the client 109, the monitoring application 120 may tag the current data event as being suspicious or unusual (e.g., in the event record 126). The monitoring application 120 may also notify the clients 109 of the suspicious or unusual activity of the client 109, and request the client 109 to confirm that the current data event 209 of the client 109 is true and not fraudulent.

While steps 218, 221, and 224 are shown in FIG. 2 in a particular order, it should be appreciated that steps 218, 221, and 224 need not be performed in any particular order. In some cases, one or more of steps 218, 221, and 224 need not be performed at all. Rather, steps 218, 221, and 224 are merely examples of the monitoring application 120 performing auditing or governance actions based on the records 126, 144, 147, 150, 153 stored at the repository 123.

Referring now to FIG. 3, shown is a method 300 for data platform monitoring according to various embodiments of the disclosure. Method 300 may be performed by the monitoring application 120 in the monitoring system 106 or in the data platform 103. The method 300 may include similar mechanisms as discussed above with reference to FIG. 1-2. In embodiments, the method 300 may be implemented using a computer system with components as shown in FIG. 6. As illustrated, method 300 of FIG. 3 includes a number of enumerated operations, but embodiments of the operations in FIG. 3 may include additional operations before, after, and in between the enumerated operations. In some embodiments, one or more of the enumerated operations may be omitted or performed in a different order.

At step 303, method 300 may comprise monitoring, by a monitoring application 120 of a monitoring system 106 in the communication network 100, a plurality of data events 209 across one or more data platforms 103 in the communication network 100. Each of the data events 209 corresponds to an encryption operation or a decryption operation of a data record 115 in the one or more data platforms 103. At step 305, method 300 comprises recording, by the monitoring application 120, each of the data events 209 into an event record 126. Each event record 126 corresponding to a data event 209 indicates at least one of client data 129 describing a client 109 associated with the data event 209, the data record 115 associated with the data event 209, a key 117 used for the data event 209, whether the data event 209 corresponds to the encryption operation or the decryption operation, or time data 138 of the data event 209.

At step 307, method 300 comprises generating, by the monitoring application 120, client usage records 147 based on first event records 126 detailing a first set of one or more data events 209 caused by a request 205 from the client 109. At step 309, method 300 comprises generating, by the monitoring application 120, data access records 150 based on second event records 126 detailing a second set of one or more data events 209 associated with the encryption operation or the decryption operation performed on the data record 115. At step 311, method 300 comprises generating, by the monitoring application 120, key usage records 147 based on third event records 126 detailing a third set of one or more data events 209 in which a key 117 was used during the encryption operation or the decryption operation. At step 313, method 300 comprises generating, by the monitoring application 120, platform usage records 153 based on fourth event records 126 detailing a fourth set of one or more data events 209 occurring at a data platform 103. At step 315, method 300 comprises performing, by the monitoring application 120, an action associated with at least one of the data records 115, the key 117, or the client 109 based on at least one of the event records 126, the client usage records 144, the data access records 150, the key usage records 147, and/or the platform usage records 153.

In an embodiment, method 300 may include various other elements or steps not otherwise shown in FIG. 3. In an embodiment, method 300 may further comprise generating, by the monitoring application 120, a periodic usage report for the client 109 based on the client usage records 144, the periodic usage report indicating data associated with operations performed across the one or more data platforms 103 by the client 109 within a predefined period of time, and transmitting, by the monitoring application 120, the periodic usage report to the client 109. In an embodiment, the periodic usage report comprises text, a table, and/or a graph visually representing the operations performed across the one or more data platforms 103 by the client 109 within the predefined period of time. The predefined period of time may be one month, one day, one hour, one year, or any other period of time.

In an embodiment, method 300 may further comprise determining, by the monitoring application 120, based on a rule 156 associated with the client 109, a frequency that the client 109 used the key 117 for encryption or decryption across the one or more data platforms 103 based on the key usage records 147, comparing, by the monitoring application 120, the frequency with a threshold 158 indicated in the rule 156 to determine whether the frequency is less than the threshold 158. When the frequency is less than the threshold 158, the method 300 may further comprise preventing, by the monitoring application 120, the client 109 from using the key 117 for future encryption or decryption operations across the one or more data platforms 103, and causing, by the monitoring application 120, an active directory 208 of the one or more data platforms 103 to be updated to indicate that the client 109 is prohibited from using the key 117. In an embodiment, method 300 may further comprise storing, by the monitoring application 120, a rule 156 in a repository 123 at the monitoring system 106, the rule 156 indicates an identifier of the client 109, a condition to be met, and/or the action to be performed by the monitoring application 120 when the condition is met.

In an embodiment, method 300 may further comprise identifying, by the monitoring application 120, a current data event 209 triggered by the client 109 that is tagged as suspicious based on the client usage records 144 and a rule 156 associated with the client 109, and transmitting, by the monitoring application 120, a notification to the client 109 regarding the current data event 209 caused by the client 109 that is tagged as suspicious with a request for the client 109 to confirm the current data event as being true or fraudulent activity. Method 300 may further comprise tagging, by the monitoring application 120, the one or more data events 209 triggered by the client 109 as suspicious when the current data event 209 is associated with a count that exceeds a threshold 158 indicated in the rule 156. For example, the client usage records 144 may indicate that the client 109 has historically encrypted N number of data records 115 at the data platform 103 over the course of one month, and a rule 156 may indicate that when the client 109 requests encryption for greater than X number of data records 115 over the course of one month, the monitoring application 120 may tag the data events 209 as being suspicious.

In an embodiment, method 300 may further comprise governing, by the monitoring application 120, future decryption or encryption operations requested to be performed by the client 109 based on at least one of the event records 126, client usage records 144, data access records 150, key usage records 147, platform usage records 153, and one or more rules 156. The governing may be performed similar to steps 218, 221, and 224 of FIG. 2.

Referring now to FIG. 4, shown is a method 400 for data platform monitoring according to various embodiments of the disclosure. Method 400 may be performed by the monitoring application 120 in the monitoring system 106 or in the data platform 103. The method 400 may include similar mechanisms as discussed above with reference to FIG. 1-2. In embodiments, the method 400 may be implemented using a computer system with components as shown in FIG. 6. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 may comprise monitoring, by a monitoring application 120 of a monitoring system 106 in the communication network, a plurality of data events 209 across one or more data platforms 103 in the communication network 100. Each of the data events 209 corresponds to an encryption operation or a decryption operation of a data record 115 in the one or more data platforms 103. At step 405, method 400 comprises recording, by the monitoring application 120, each of the data events 209 into an event record 126. Each event record 126 corresponding to a data event 209 indicates at least one of client data 129 describing a client 109 associated with the data event 209, the data record 115 associated with the data event 209, a key 117 used for the data event 209, whether the data event 209 corresponds to the encryption operation or the decryption operation, or time data 138 of the data event 209.

At step 407, method 400 comprises generating, by the monitoring application 120, client usage records 144 based on first event records 126 detailing a first set of one or more data events 209 caused by a request 205 from the client 109. At step 409, method 400 comprises generating, by the monitoring application 120, key usage records 147 based on second event records 126 detailing a second set of one or more data events 209 in which a key 117 was used during the encryption operation or the decryption operation. At step 411, method 400 comprises determining, by the monitoring application 120, a frequency that the client 109 used the key 117 for encryption or decryption across the one or more data platforms 103 based on the key usage records 147. The frequency may refer to a quantity of times that the client 109 used to key 118 for encryption or decryption with a predefined period of time.

At step 413, method 400 comprise comparing, by the monitoring application 120, the frequency with a threshold 158 indicated in a rule 156 associated with the client 109 to determine whether the frequency is less than the threshold 158 (e.g., the threshold 158 may be one). At step 415, when the frequency is less than the threshold 158, the method 400 further comprises preventing, by the monitoring application 120, the client 109 from using the key 117 for future encryption or decryption operations across the one or more data platforms 103, and causing, by the monitoring application 120, one or more active directories 208 of the one or more data platforms 103 to indicate that the client 109 is prohibited from using the key 117.

In an embodiment, method 400 may include various other elements or steps not otherwise shown in FIG. 4. In an embodiment, method 400 may further comprise tagging, by the monitoring application 120, a current data event 209 triggered by the client 109 as suspicious based on the client usage records 144 and a rule 156, and transmitting, by the monitoring application 120, a notification to the client 109 regarding the current data event 209 triggered by the client 109 that is tagged as suspicious with a request for the client 109 to verify the one or more data events 209 (e.g., confirm whether the client activity in the current data event 209 is intended and true or is potentially fraudulent activity). In an embodiment, method 400 may further comprise governing, by the monitoring application 120, future decryption or encryption operations requested to be performed by the client 109 based on at least one of the event records 126, the client usage records 144, and one or more rules 156.

In an embodiment, method 400 may further comprise generating, by the monitoring application 120, a periodic usage report for the client 109 based on the client usage records 144, and transmitting, by the monitoring application 120, the periodic usage report to the client 109. The periodic usage report indicates data associated with operations performed across the one or more data platforms 103 by the client 109 within a predefined period of time. The periodic usage report comprises text, a table, and/or a graph visually representing the operations performed across the one or more data platforms 103 by the client 109 within the predefined period of time.

In an embodiment, method 400 may further comprise generating, by the monitoring application 120, data access records 150 based on third event records 126 detailing a third set of one or more data events 209 associated with the encryption operation or the decryption operation performed on the data record 115, or generating, by the monitoring application 120, platform usage records 153 based on fourth event records 126 detailing a fourth set of one or more data events 209 occurring at a data platform 103.

Referring now to FIG. 5, shown is a method 500 for data platform monitoring according to various embodiments of the disclosure. Method 500 may be performed by the monitoring application 120 in the monitoring system 106 or in the data platform 103. The method 500 may include similar mechanisms as discussed above with reference to FIG. 1-2. In embodiments, the method 500 may be implemented using a computer system with components as shown in FIG. 6. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 may comprise monitoring, by a monitoring application 120 of a monitoring system 106 in the communication network 100, a plurality of data events 209 across one or more data platforms 103 in the communication network 100. Each of the data events 209 corresponds to an encryption operation or a decryption operation of a data record 115 in the one or more data platforms 103. At step 505, method 500 comprises recording, by the monitoring application 120, each of the data events 209 into an event record 126. Each event record 126 corresponding to a data event 209 indicates at least one of client data 129 describing a client 109 associated with the data event 209, the data record 115 associated with the data event 209, a key 117 used for the data event 209, whether the data event 209 corresponds to the encryption operation or the decryption operation, or time data 138 of the data event 209.

At step 507, method 500 comprises generating, by the monitoring application 120, client usage records 144 based on event records 126 detailing a set of one or more data events 209 triggered by a request 205 from the client 109. At step 509, method 500 comprises generating, by the monitoring application 120, a periodic usage report for the client 109 based on the client usage records 144. The periodic usage report indicates data associated with operations performed across the one or more data platforms 103 by the client 109 within a predefined period of time. At step 511, method 500 comprises transmitting, by the monitoring application 120, the periodic usage report to the client 109.

In an embodiment, method 500 may include various other elements or steps not otherwise shown in FIG. 5. In an embodiment, method 500 may further comprise generating, by the monitoring application 120, data access records 150 based on second event records 126 detailing a second set of one or more data events 209 associated with the encryption operation or the decryption operation performed on the data record 115. In an embodiment, method 500 may further comprise generating, by the monitoring application 120, key usage records 147 based on third event records 126 detailing a third set of one or more data events 209 in which a key 117 was used during the encryption operation or the decryption operation. In an embodiment, method 500 may further comprise generating, by the monitoring application 120, platform usage records 153 based on fourth event records 126 detailing a fourth set of one or more data events 209 occurring at the one or more data platforms 103.

In an embodiment, the periodic usage report comprises text, a table, and/or a graph visually representing the operations performed across the one or more data platforms 103 by the client within the predefined period of time. In an embodiment, method 500 may further comprise generating, by the monitoring application 120, an updated periodic usage report for the client 109 based on the client usage records 144 periodically according to a predefined time interval.

FIG. 6 illustrates a computer system 600 suitable for implementing one or more embodiments disclosed herein. In an embodiment, the monitoring system 106 and/or the monitoring application 120 may be implemented as the computer system 600. The computer system 600 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 600, at least one of the CPU 382, the RAM 388, and the ROM 386 are changed, transforming the computer system 600 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 600 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 384, to the ROM 386, to the RAM 388, and/or to other non-volatile memory and volatile memory of the computer system 600. The processor 382 may process the executable instructions and/or data structures in part by directly accessing the computer program product, for example by reading from a CD-ROM disk inserted into a disk drive peripheral of the computer system 600. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 600.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 600 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network to perform data platform monitoring and auditing, comprising:
monitoring, by a monitoring application of a monitoring system in the communication network, a plurality of data events across one or more data platforms in the communication network, wherein each of the data events corresponds to an encryption operation or a decryption operation of a data record in the one or more data platforms;
recording, by the monitoring application, each of the data events into an event record, wherein each event record corresponding to a data event indicates at least one of client data describing a client associated with the data event, the data record associated with the data event, a key used for the data event, whether the data event corresponds to the encryption operation or the decryption operation, or a timestamp of the data event;
generating, by the monitoring application, client usage records based on event records detailing a set of one or more data events triggered by a request from the client;
generating, by the monitoring application, a periodic usage report for the client based on the client usage records, wherein the periodic usage report indicates data associated with operations performed across the one or more data platforms by the client within a predefined period of time; and
transmitting, by the monitoring application, the periodic usage report to the client.

2. The method of claim 1, further comprising generating, by the monitoring application, data access records based on second event records detailing a second set of one or more data events associated with the encryption operation or the decryption operation performed on the data record.

3. The method of claim 1, further comprising generating, by the monitoring application, key usage records based on third event records detailing a third set of one or more data events in which a key was used during the encryption operation or the decryption operation.

4. The method of claim 1, further comprising generating, by the monitoring application, platform usage records based on fourth event records detailing a fourth set of one or more data events occurring at the one or more data platforms.

5. The method of claim 1, wherein the periodic usage report comprises text, a table, and a graph visually representing the operations performed across the one or more data platforms by the client within the predefined period of time.

6. The method of claim 1, further comprising generating, by the monitoring application, an updated periodic usage report for the client based on the client usage records periodically according to a predefined time interval.

7. A method implemented in a communication network to perform data platform monitoring and auditing, comprising:
monitoring, by a monitoring application of a monitoring system in the communication network, a plurality of data events across one or more data platforms in the communication network, wherein each of the data events corresponds to an encryption operation or a decryption operation of a data record in the one or more data platforms;
recording, by the monitoring application, each of the data events into an event record, wherein each event record corresponding to a data event indicates at least one of client data describing a client associated with the data event, the data record associated with the data event, a key used for the data event, whether the data event corresponds to the encryption operation or the decryption operation, or a timestamp of the data event;
generating, by the monitoring application, client usage records based on first event records detailing a first set of one or more data events caused by a request from the client;
generating, by the monitoring application, key usage records based on second event records detailing a second set of one or more data events in which a key was used during the encryption operation or the decryption operation;
determining, by the monitoring application, a frequency that the client used the key for encryption or decryption across the one or more data platforms based on the key usage records;
comparing, by the monitoring application, the frequency with a threshold indicated in a rule associated with the client to determine whether the frequency is less than the threshold; and
when the frequency is less than the threshold:
preventing, by the monitoring application, the client from using the key for future encryption or decryption operations across the one or more data platforms; and
causing, by the monitoring application, one or more active directories of the one or more data platforms to indicate that the client is prohibited from using the key.

8. The method of claim 7, further comprising:
tagging, by the monitoring application, a current data event triggered by the client as suspicious based on the client usage records and a rule; and
transmitting, by the monitoring application, a notification to the client regarding the current data event triggered by the client that is tagged as suspicious with a request for the client to verify the one or more data events.

9. The method of claim 7, further comprising governing, by the monitoring application, future decryption or encryption operations requested to be performed by the client based on at least one of the event records, the client usage records, and one or more rules.

10. The method of claim 7, further comprising:
generating, by the monitoring application, a periodic usage report for the client based on the client usage records, wherein the periodic usage report indicates data associated with operations performed across the one or more data platforms by the client within a predefined period of time; and
transmitting, by the monitoring application, the periodic usage report to the client.

11. The method of claim 7, further comprising transmitting, by the monitoring application to the client, an efficient function call to search for one or more data records.

12. The method of claim 7, further comprising:
generating, by the monitoring application, data access records based on third event records detailing a third set of one or more data events associated with the encryption operation or the decryption operation performed on the data record; or
generating, by the monitoring application, platform usage records based on fourth event records detailing a fourth set of one or more data events occurring at a data platform.

13. A method implemented in a communication network to perform data platform monitoring and auditing, comprising:
monitoring, by a monitoring application of a monitoring system in the communication network, a plurality of data events across one or more data platforms in the communication network, wherein each of the data events corresponds to an encryption operation or a decryption operation of a data record in the one or more data platforms;
recording, by the monitoring application, each of the data events into an event record, wherein each event record corresponding to a data event indicates at least one of client data describing a client associated with the data event, the data record associated with the data event, a key used for the data event, whether the data event corresponds to the encryption operation or the decryption operation, or a timestamp of the data event;
generating, by the monitoring application, client usage records based on first event records detailing a first set of one or more data events caused by a request from the client;
generating, by the monitoring application, data access records based on second event records detailing a second set of one or more data events associated with the encryption operation or the decryption operation performed on the data record;
generating, by the monitoring application, key usage records based on third event records detailing a third set of one or more data events in which a key was used during the encryption operation or the decryption operation;
generating, by the monitoring application, platform usage records based on fourth event records detailing a fourth set of one or more data events occurring at a data platform; and
performing, by the monitoring application, an action associated with at least one of the data records, the key, or the client based on at least one of the event records, the client usage records, the data access records, the key usage records, and/or the platform usage records.

14. The method of claim 13, further comprising:
generating, by the monitoring application, a periodic usage report for the client based on the client usage records, wherein the periodic usage report indicates data associated with operations performed across the one or more data platforms by the client within a predefined period of time; and
transmitting, by the monitoring application, the periodic usage report to the client.

15. The method of claim 14, wherein the periodic usage report comprises text, a table, and a graph visually representing the operations performed across the one or more data platforms by the client within the predefined period of time.

16. The method of claim 13, further comprises:
determining, by the monitoring application, based on a rule associated with the client, a frequency that the client used the key for encryption or decryption across the one or more data platforms based on the key usage records;
comparing, by the monitoring application, the frequency with a threshold indicated in the rule to determine whether the frequency is less than the threshold; and
when the frequency is less than the threshold:
preventing, by the monitoring application, the client from using the key for future encryption or decryption operations across the one or more data platforms; and
causing, by the monitoring application, an active directory of the one or more data platforms to be updated to indicate that the client is prohibited from using the key.

17. The method of claim 13, further comprising storing, by the monitoring application, a rule in a repository at the monitoring system, wherein the rule comprises an identifier of the client, a condition to be met, and the action to be performed by the monitoring application when the condition is met.

18. The method of claim 13, further comprising:
identifying, by the monitoring application, a current data event triggered by the client that is tagged as suspicious based on the client usage records and a rule associated with the client; and
transmitting, by the monitoring application, a notification to the client regarding the current data event triggered by the client that is tagged as suspicious with a request for the client to confirm the current data event as being true or fraudulent activity.

19. The method of claim 18, further comprising tagging, by the monitoring application, the one or more data events triggered by the client as suspicious when the current data event is associated with a count that exceeds a threshold indicated in the rule.

20. The method of claim 13, further comprise governing, by the monitoring application, future decryption or encryption operations requested to be performed by the client based on at least one of the event records, client usage records, data access records, key usage records, platform usage records, and one or more rules.
